(19) United States
(12) Patent Application Publication
(10) Pub. No.: US 2024/0281273 A1
(43) Pub. Date: Aug. 22, 2024

(54) CONTAINER MONITORING AND METRICS AGGREGATION SOLUTION

(71) Applicant: Hewlett Packard Enterprise Development LP, Spring, TX (US)

(72) Inventors: Ravi Shekhar Jha, Galway (IE); Eoghan Shields, Galway (IE)

(73) Assignee: Hewlett Packard Enterprise Development LP, Spring, TX (US)

(21) Appl. No.: 18/172,272

(22) Filed: Feb. 21, 2023

(51) Int. Cl. G06F 9/455; G06F 16/28

(52) U.S. Cl. CPC G06F 9/45558; G06F 16/287; G06F 2009/45575; G06F 2009/45591; G06F 2009/45595

(57) ABSTRACT

Techniques are provided for monitoring Containers-as-a-Service (CaaS) platforms, including monitoring containers and applications in the platform and aggregating the metrics thereof. A container has applications running in the container. A container event associated with the container is detected. Based on the detection of the container event, an enforcer command is executed. The enforcer command enables an enforcer application within the container. The enabled enforcer application obtains performance data associated with the container and the application. At least one message packet comprising the performance data is transmitted to an application performance database.

### BACKGROUND

Containers-as-a-Service (CaaS) is a platform of container-based virtualization where container engines, orchestration and underlying computing resources are delivered to users as a service from a CaaS provider. A CaaS platform manages containers at a large scale, including starting, stopping, and organizing containerized workloads. A CaaS platform often has a plurality of applications running simultaneously in a plurality of containers launched by the applications.

### BRIEF DESCRIPTION OF THE DRAWINGS

Various objects, features, aspects and advantages of the inventive subject matter will become more apparent from the following specification, along with the accompanying drawings in which like numerals represent like components.

FIG. 1 is a diagram illustrating the lifecycle of a container in accordance with an example.

FIG. 2 illustrates an example system diagram of a container monitoring solution.

FIG. 3 illustrates a flow diagram of a container monitoring and metrics aggregation method in accordance with an example.

FIG. 4 illustrates a flow diagram of a container monitoring and metrics aggregation method with displaying features in accordance with an example.

FIG. 5 illustrates a process flow based on an example container monitoring system.

FIG. 6 illustrates a computer-readable medium in accordance with an example.

FIG. 7 illustrates a block diagram of a distributed computer system that can be used for implementing one or more aspects of the various examples.

While the examples are described with reference to the above drawings, the drawings are intended to be illustrative, and other examples are consistent with the spirit, and within the scope, of the various examples herein.

### DETAILED DESCRIPTION

In a CaaS environment, containers are complete applications, each packaged with application code, libraries, dependencies, and system tools to run on a variety of platforms and infrastructure. Because containers generally have low usage of system resources and are platform independent, they have become the de facto compute units of modern cloud-native applications.

Although one may manually deploy containers across platforms, deploying a vast number of containers across a variety of platforms can be very challenging without automated methods for load-balancing, resource allocation, and security enforcement. Container orchestration automates the scheduling, deployment, networking, scaling, health monitoring, and management of containers. A platform that uses container orchestration to manage containers is referred to as a container orchestration engine, a container orchestration platform, a container orchestration environment, or a container orchestration tool in the industry and throughout this disclosure. When scheduling the deployment of containers to a host, a container orchestration engine chooses the best host to deploy based on the available computing resources of the host and the requirements of containers.

After containers are deployed by the container orchestration engine, the container orchestration engine also manages the lifecycle of the container and the containerized applications running within the container. The management of containers includes managing the scalability, load balancing, and resource allocation among containers. The management may also include ensuring the availability and performance of containers by relocating the containers to other hosts in the event of host outage or resource shortage.

One method of container orchestration is based on a swarm. A swarm is a collection of physical or virtual machines that have been configured to join together in a cluster. Nodes are physical or virtual machines that have joined the cluster. A typical swarm has at least one manager node and many worker nodes.

A manager node is used to dispatch tasks to worker nodes in the swarm. The manager node also performs the orchestration and cluster management functions to maintain the state of the swarm. Worker nodes receive tasks from manager nodes and execute required actions for the swarm, such as starting or stopping a container.

Implementing a CaaS platform performance monitoring solution has several challenges. One challenge is that the monitoring solution needs to monitor at runtime the performance and statistical data of not only various containers operating in various stages, but also various applications running within each container. This can be challenging when hundreds or thousands of containers, and the applications running therein, are being started, restarted, and exited at any given moment. Failing to overcome this challenge, some existing solutions can only monitor containers that are currently running, but not the containers that are exiting or getting restarted. Moreover, some other existing solutions can only monitor the status of containers from a host perspective, i.e., from outside the containers, but often have limited or no capabilities for monitoring applications running within each container.

Another challenge of implementing a CaaS platform performance monitoring solution is the timing of launching the monitoring program. A monitoring service is an application or service provided by the platform provider. Because containers are oftentimes configured and provided by users, some existing solutions require users to pre-launch the monitoring program in containers before the containers are provided to the platform. However, such imposition on platform users to pre-launch a monitoring program can be impractical to the users, especially when hundreds of containers need to be pre-launched with monitoring programs by the users. Moreover, some existing solutions require a platform provider to provide the monitoring program to users prior to the users using the platform. This entails significant coordination between platform provider and users, especially because the monitoring program needs to be constantly updated by the provider. A wrong version of the monitoring program run by a user may cause the container to crash. Thus, a CaaS platform should be able to launch the monitoring program within each container after the container is being instantiated and running, so that users do not need to pre-launch the monitoring program. However, existing solutions have failed to overcome this challenge.

Yet another challenge of implementing a CaaS platform performance monitoring solution is that a monitoring solution needs to keep a minimal footprint on infrastructure resources of the containers and applications. Existing solutions are typically resource-intensive applications with respect to the overall computing resources of the CaaS platform.

Thus, the techniques disclosed herein for container monitoring and metrics aggregation solution are clearly advantageous for monitoring a CaaS platform. The disclosed techniques provide ways to monitor containers operating in various stages, and both from a host perspective and from inside each container. The disclosed techniques provide ways to monitor containers brought by users to the CaaS platform, and allow monitoring containers without pre-launching any monitoring programs in each container individually. The disclosed techniques allow monitoring applications running in containers to keep a minimal footprint on the infrastructure resources. As a result, the disclosed techniques can provide in real time all the details about the usage, type and runtime environment of the applications running on the infrastructure, and thereby greatly improve the efficiency and capability of monitoring containers and applications within a CaaS environment.

According to an example of the system described herein, a container has applications running in the container. A container event associated with the container is detected. Based on the detection of the container event, an enforcer command is executed. The enforcer command enables an enforcer application within the container. The enabled enforcer application obtains performance data associated with the container and the application. At least one message packet comprising the performance data is transmitted to an application performance database.

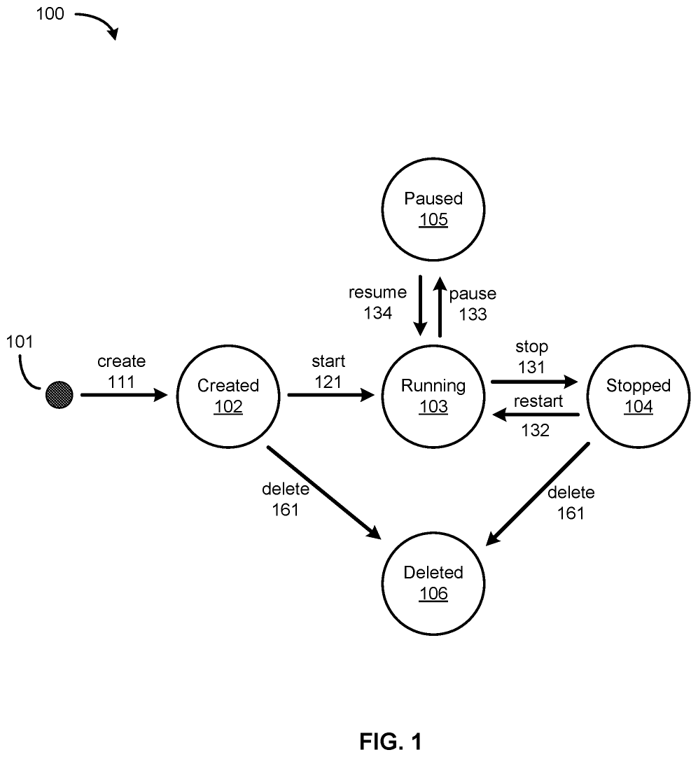

FIG. 1 is a diagram illustrating the lifecycle of a container in accordance with an example. As described above, a container is managed by a container orchestration engine and is created and deleted by a worker node in the container orchestration engine. Container lifecycle 100 contains an initial state 101, a Created state 102, a Running state 103, a Stopped state 104, a Paused state 105, and a Deleted state 106. Starting from initial state 101, the worker node in the container orchestration engine receives a create command 111 from a manager node. In some examples, create command 111 also includes a container image, which is a static file that includes executable code of the new container. The worker node then creates a new container from the container image, bringing the state of the container to Created state 102.

Containers may generate one or more events when changing from one state to another. For example, when the container changes from initial state 101 to Created state 102, the container may generate a CREATE event.

In other examples, some events may be generated while the container remains in one state. For example, while the container is in Running state 103, the container may generate an UPDATE event when the configuration of the container is updated.

After the container is created, the worker node may receive a start command 121 to start the container. The worker node then starts the container by executing the commands in the container image, which bring the container up and running to Running state 103. When the container changes its state from Created state 102 to Running state 103, a START event may be generated by the container.

Running state 103 is the main operating state of a container in container lifecycle 100. While the container is running, one or more new applications may be created within the container. New applications are created, run and completed by executing commands in the container image, or by executing external commands from the platform user.

While the container is in Running state 103, the worker node may receive a pause command 133 to pause the container, thereby bringing the container to the Paused state 105. At Paused state 105, execution of the current command in the container is paused. However, one or more other processes in the container remain alive and are ready to resume execution as soon as a resume command is received. While at Paused state 105, if the worker node receives a resume command 134, the worker node resumes executing the commands in the container and brings the state of the container back to Running state 103.

While the container is in Running state 103, the worker node may also receive a stop command 131 to stop the container. A stop command shuts down the container's main process gracefully (as opposed to an immediate or “hard” shutdown) and brings the container to Stopped state 104. At Stopped state 104, the container's main process, along with any new applications created by the main process, are shut down and inactivated. However, a process for listening external commands is still running in the container. When a restart command 132 is received by the worker node, the worker node brings the container back to Running state 103 by re-executing the commands in the container image. When the container changes its state from Stopped state 104 to Running state 103, a RESTART event may be generated by the container.

While the container is in Created state 102 or Stopped state 104, a delete command 161 received by the worker node can bring the container to Deleted state 106. At Deleted state 106, the container's main process is shut down immediately and deleted. If a container is in Deleted state 106, the state of the container cannot be brought back to Running state 103.

While the container is in a state other than Deleted state 106, the worker node may receive an update command (not shown in the figure) from the manager node to update the configuration of the container. This typically happens when the container is relocated by the container orchestration engine to a new host in the cluster because of host outage or resource shortage on the existing host. Upon receiving the update command, the worker node will update the configuration, such as computing resources, of the container. When the container is being updated, an UPDATE event may be generated by the container.

It should be understood that besides the START, RESTART and UPDATE events, a container may generate other container events not listed above. For example, a PAUSE event may be generated when a container changes its state from Running state 103 to Paused state 105; a STOP event may be generated when the container state is changed from Running state 103 to Stopped state 104; a DELETE event may be generated when the container state is changed from Stopped state 104 to Deleted state 106. Sometimes, container events may be generated when the container receives certain commands from the manager node, or when the container experiences changes in operation or configuration, such as the UPDATE event previously discussed, or a RESIZE event, etc.

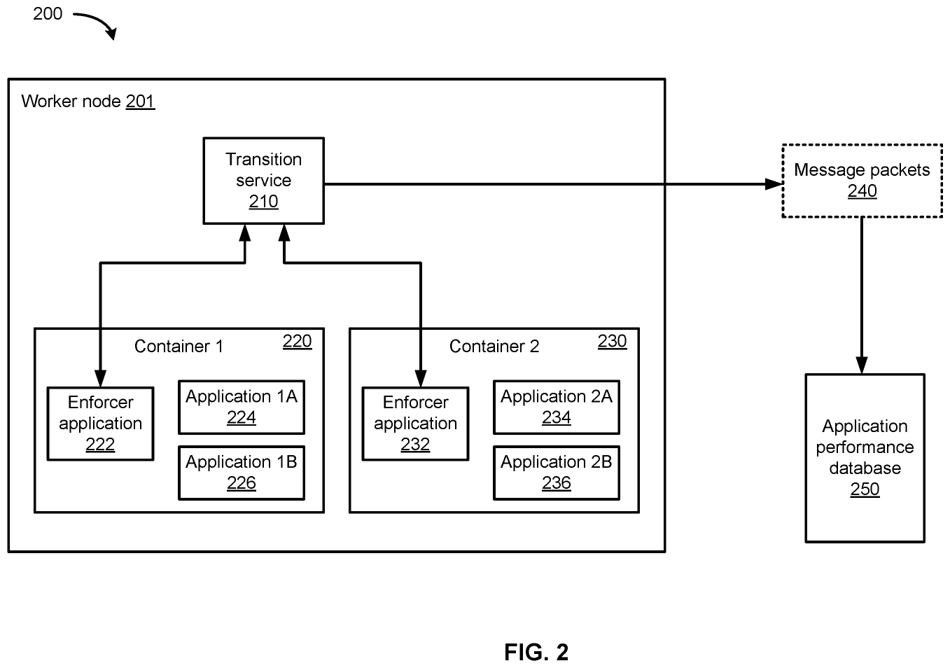

FIG. 2 illustrates an example system diagram of a container monitoring solution. Container monitoring system 200 comprises worker node 201 and application performance database 250. As described above, worker node 201 is part of a container orchestration engine. In some examples, the container orchestration engine is a swarm. Worker node 201 receives commands from a manager node in the swarm to execute required actions. The commands may include, but are not limited to, a “create” command, a “start” command, a “stop” command, a “restart” command, a “pause” command, a “resume” command, and a “delete” command. Upon receiving these commands from the manager node, worker node 201 changes the state of containers from one state to the next according to the lifecycle of a container.

Container 1 (reference 220, or container 220) and Container 2 (reference 230, or container 230) are two containers running in worker node 201. They are created by worker node 201 in response to two “create” commands from a manager node in the swarm. Worker node 201 may have other containers created and running (not shown in the figure). Once the containers are created, they are changed by worker node 201 to different container states in the container lifecycle based on new commands received from the manager node. As described above, a container may operate in a Created state, a Running state, a Stopped state, a Paused state, or a Deleted state.

Transition service 210 is a service running in worker node 201. It is a global service that runs on all worker nodes of a container orchestration engine. Containers may have one or more applications created and running in the containers. For example, Application 1A (reference 224) and Application 1B (reference 226) are two applications created and running in container 220. Application 2A (reference 234) and Application 2B (reference 236) are two applications created and running in container 230. Containers 220 and 230 may have more than two applications created and running (not shown in the figure). As described above, applications in container are created, run and completed while the container is in the Running state.

Container 220 includes enforcer application 222, which is a specific application running in container 220. The function of enforcer application 222 is to capture the performance data of container 220 and the performance data of applications 224 and 226 running in container 220. Likewise, enforcer application 232 is a specific application running in container 230 to capture the performance data of container 230 and the performance data of applications 234 and 236 running in container 230. In other examples, enforcer application may run from outside of containers 220 and 230, but still in worker node 201, to capture runtime statistics of other containers running in the work node. It should be understood that the discussion below regarding enforcer application 222, applications 224 and 226 in container 220 also apply to enforcer application 232 and applications 234 and 236 in container 230.

Transition service 210 monitors container events generated by or associated with all containers in worker node 201. When certain container events are generated by container 220, the events will be detected by transition service 210. In some examples, not all the detected events are acted upon by system 200. Transition service 210 may only detect and act upon certain container events specified by a platform user. For example, transition service 210 may act upon START, RESTART and UPDATE events, but not upon PAUSE or DELETE events. When a user specified container event is detected, transition service 210 initiates enforcer application 222 and injects the enforcer application into container 220. Enforcer application 222 is then executed at runtime of the container event. Enforcer application 222 obtains in real time the performance data of container 220 and all the applications running within the container, including applications 224 and 226, and other applications not shown in the figure. Enforcer application 222 then sends the gathered performance data in real time to transition service 210.

As described above, container events may include a START event, a RESTART event, and an UPDATE event, etc. Depending on the different container event detected by transition service 210, transition service 210 may initiate the enforcer application in slightly different ways. For example, if a START event is detected by transition service 210, meaning that container 220 is changing its state from the Created state to the Running state, transition service 210 will supply and run at least one compatible script to initiate a new instance of enforcer application 222 in container 220.

In addition, as described above, when container 220 changes its state from a Running state to a Stopped state, the container's main process is shut down gracefully. However, the instance of enforcer application 220 initiated in response to the START event still remains, although not actively running. If a RESTART event is detected by transition service 210, meaning that container 220 is changing its state from the Stopped state to the Running state, transition service 210 will supply and run at least one compatible script to restart the existing instance of enforcer application 222 in container 220.

Moreover, as described above, container 220 may generate an UPDATE event when the container is being relocated by the container orchestration engine to a new host, and the configuration of container 220 will be updated to the computing resources of the new host. While container 220 is being relocated, the enforcer application 222 is still running in the container. Enforcer application 222 also needs to be updated so that it may gather new performance data from the container running in the new host. If an UPDATE event is detected by transition service 210, transition service 210 will supply and run at least one compatible script to update the existing instance of enforcer application 222 in container 220.

After transition service 210 receives the gathered performance data from enforcer application 220, transition service 210 generates message packets 240 by transforming the gathered performance data into message packets comprising the performance data. Application performance database 250 is then updated with message packets 240 by appropriate database query commands. In some examples, after the message packets are generated, they are transmitted by worker node 201 to certain message broker systems (not shown in the figure) for further processing. One such message broker system may be the RabbitMQ open-source message broker system. Since a message broker collects message packets from worker node 201 without actually interfering with the processing of the worker node, there is minimal resource usage by the message broker on the host system.

In some examples, a separate message buffering service (not shown in the figure), such as a Tee-Up service, may be used to process the performance data information in the message packets and convert them into appropriate database query commands appropriate for writing into application performance database 250. Application performance database 250 may be a relational database, or a non-tabular database, also called a NoSQL database, such as the MongoDB developer data platform or ArangoDB open-source native graph database system. This separate message buffering service is configured to work independently from work node 201. Therefore, the service can be easily scaled up to speed up the processing when there is heavy inflow of traffic due to large amount of performance data.

After the performance data is stored in application performance database 250, a separate API service (not shown in the figure) may be used to retrieve the performance data from the application performance database 250. The retrieved performance data may then be displayed via a visualization tool such as the Grafana® open-source analytics & monitoring application. The retrieved data can be displayed via the visualization tool in histogram format or tabulated format.

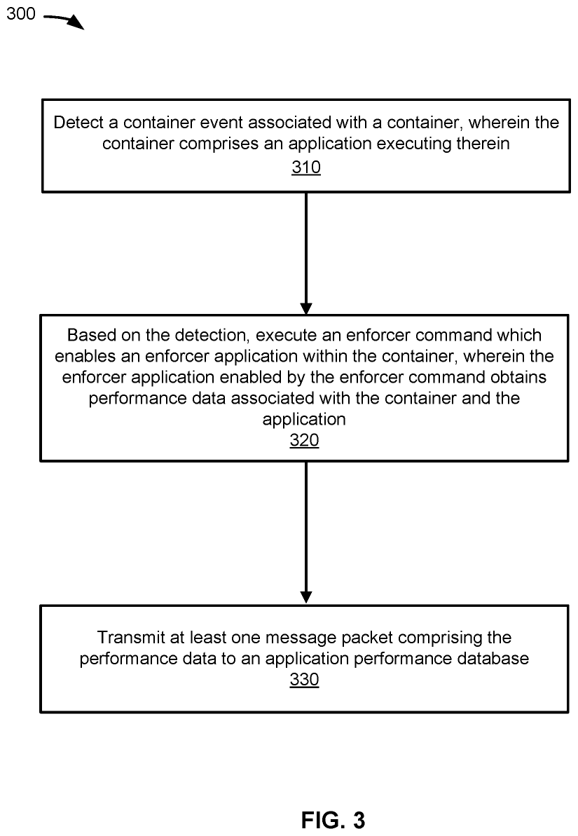

FIG. 3 illustrates a flow diagram of a container monitoring and metrics aggregation method in accordance with an example. Method 300 may be performed by a worker node in a container orchestration engine.

At step 310, a transition service detects a container event associated with a container, wherein the container comprises an application executing therein. The container is created by the worker node in response to a “create” command from a manager node in the container orchestration engine. There is at least one application running in the container. Container events may be generated by a container when the container changes from one state to another. Some container events may be generated while the container remains in one state. Container events may include a START event, a RESTART event, and an UPDATE event, etc. The transition service detects at least one container event, such as, a START event, a RESTART event, or an UPDATE event, etc., generated by the container. In some examples, not all the detected events are acted upon by the transition service. The transition service may only detect and act upon certain container events specified by a platform user. For example, the transition service may act upon START, RESTART and UPDATE events, but not upon PAUSE or DELETE events.

At step 320, based on the detection, the transition service executes an enforcer command which enables an enforcer application within the container, wherein the enforcer application enabled by the enforcer command obtains performance data associated with the container and the application. Enforcer application is a specific application running in a container to capture the performance data of the container and applications running in the container. The transition service enables the enforcer application by executing an enforcer command. The enforcer application is then executed at runtime of the container event, which obtains in real time the performance data of the container and all the applications running within the container. The enforcer application then sends the gathered performance data in real time to the transition service.

In some examples, depending on the different container event detected by the transition service, the transition service may initiate the enforcer application in slightly different ways. For example, if a START event is detected by the transition service, meaning that the container is changing its state from the Created state to the Running state, the transition service will supply and run at least one compatible script to initiate a new instance of the enforcer application in the container. If a RESTART event is detected by the transition service, meaning that the container is changing its state from the Stopped state to the Running state, the transition service will supply and run at least one compatible script to restart the existing instance of the enforcer application in the container. If an UPDATE event is detected by the transition service, the transition service will supply and run at least one compatible script to update the existing instance of the enforcer application in the container.

At step 330, the transition service transmits at least one message packet comprising the performance data to an application performance database. An application performance database is updated with the message packets by appropriate database query commands. Application performance database may be a relational database, or a non-tabular database such as MongoDB or ArangoDB. In some examples, after the message packets are generated, they are transmitted by the worker node to a message broker system, for example, RabbitMQ, for further processing. Also in some examples, a separate message buffering service may be used to process the performance data information in the message packets and convert them into appropriate database query commands appropriate for writing into application performance database.

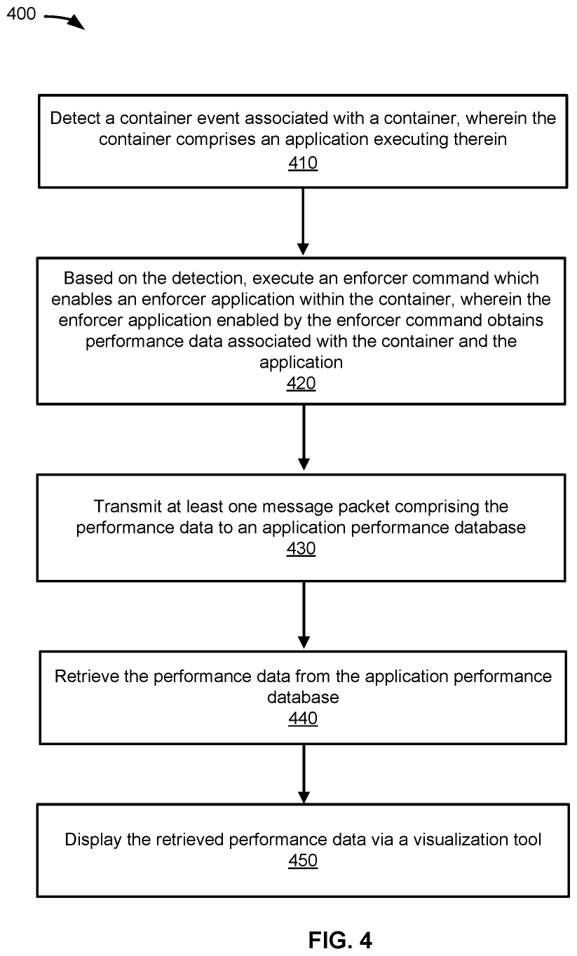

FIG. 4 illustrates a flow diagram of a container monitoring and metrics aggregation method with displaying features in accordance with an example. Method 400 may be performed by a worker node in a container orchestration engine or by a separate node or host.

Steps 410 to 430 are identical to steps 310 to 330 in FIG. 3 and will not be repeated herein.

At step 440, the message packet comprising the performance data is transmitted to the application performance database, a separate API service may be used to retrieve the performance data from the application performance database.

At step 450, the retrieved performance data may be displayed via a visualization tool such as Grafana®. The retrieved data can be displayed via the visualization tool in histogram format or tabulated format.

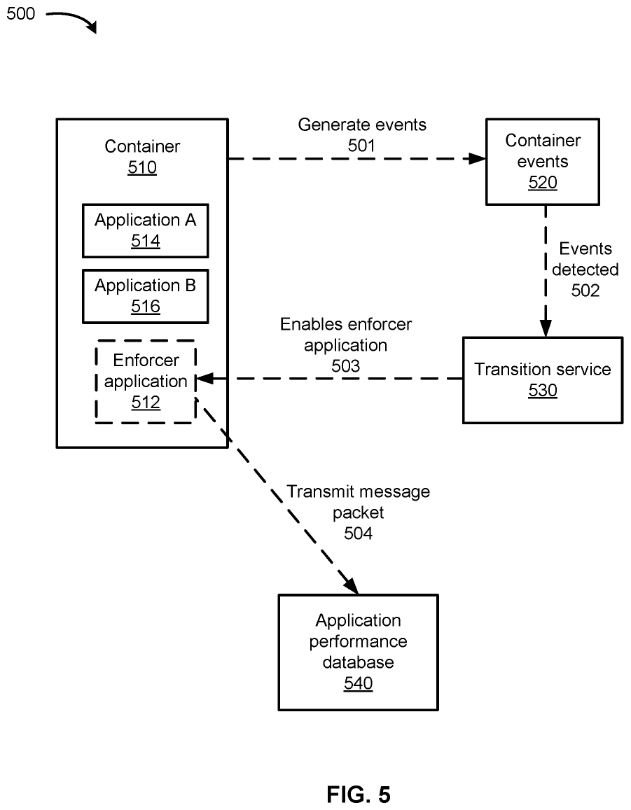

FIG. 5 illustrates a process flow based on an example container monitoring system. Process flow 500 comprises container 510, container events 520, transition service 530, and application performance database 540. Container 510 and transition service 530 are part of a worker node (not shown in the figure) of a container orchestration engine (not shown in the figure).

Container 510 is a container created by the worker node in response to a “create” command from a manager node in the container orchestration engine (not shown in the figure). After container 510 is created, container 510 may be changed by the worker node to different container states in the container lifecycle based on new commands received from the manager node. Container 510 may operate in a Created state, a Running state, a Stopped state, a Paused state, or a Deleted state.

Container 510 may have one or more applications created and running in the container. For example, Application A (reference 514) and Application B (reference 516) are two applications created and running in container 510. Container 510 may have more than two applications created and running (not shown in the figure). Container 510 also includes enforcer application 512, which is a specific application running in container 510. The function of enforcer application 512 is to capture the performance data of container 510 and the performance data of applications 514 and 516 running in container 510.

At process 501, one or more container events 520 are generated by container 510 when container 510 changes from one state to another. For example, when container 510 changes its state from the Created state to the Running state, a container event “START” may be generated by the container; or when container 510 changes its state from the Stopped state to the Running state, a RESTART event may be generated by the container. Sometimes, container event is generated when container 510 remains in one state. For example, when container 510 is being updated, an UPDATE event may be generated by the container.

At process 502, transition service 530 detects one or more container events 520 generated by or associated with container 510. In some examples, not all the detected events are acted upon by process 502. Transition service 530 may only detect and act upon certain container events specified by a platform user. For example, transition service 530 may act upon START, RESTART and UPDATE events, but not upon PAUSE or DELETE events.

At process 503, when a user specified container event 520 is detected, transition service 530 enables enforcer application 512 by executing an enforcer command, and injects the enforcer application into container 510. Enforcer application 512 is then executed at runtime of container event 520. Enforcer application 512 obtains in real time the performance data of container 510 and all the applications running within the container, including applications 514 and 516, and other applications not shown in the figure.

At process 504, enforcer application 512 transmits at least one message packet comprising the performance data to application performance database 540. Application performance database 540 receives message packets by appropriate database query commands. Application performance database 540 may be a relational database, or a non-tabular database such as MongoDB or an ArangoDB. In some examples, after the message packets 540 are generated, they are transmitted by the worker node to a message broker system, for example, RabbitMQ, for further processing. Also in some examples, a separate message buffering service may be used to process the performance data information in message packets 540 and convert them into appropriate database query commands appropriate for writing into application performance database.

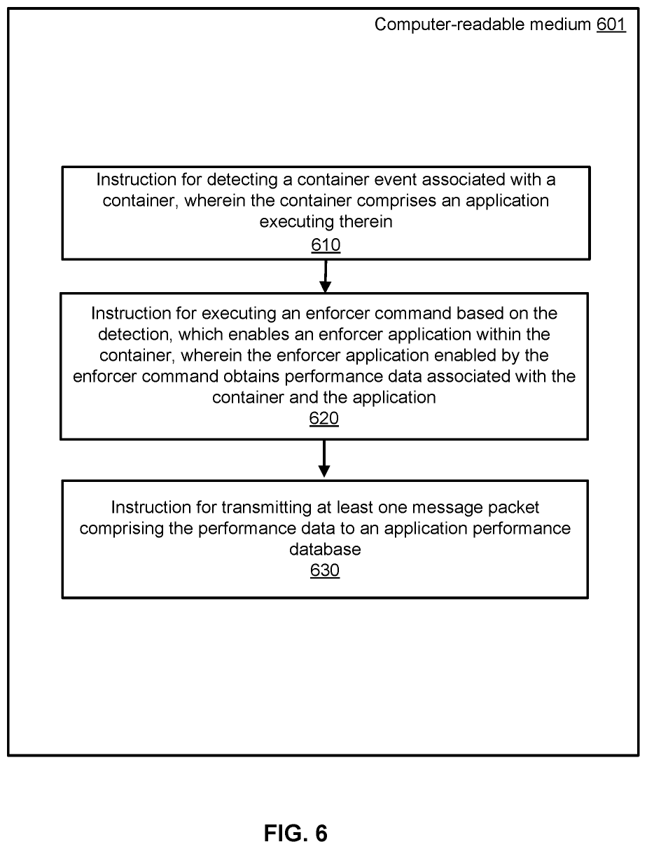

FIG. 6 illustrates a computer-readable medium in accordance with an example. In various examples, the instructions for performing the various methods herein are stored on a non-transitory computer-readable medium, e.g., computer readable medium (CRM) 601. FIG. 6 is shown from the perspective of instructions performed at a worker node for container monitoring and metrics aggregation in a CaaS platform. For example, CRM 601 may include one or more instructions 610 for detecting a container event associated with a container, wherein the container comprises an application executing therein. The container is created by the worker node in response to a “create” command from a manager node in the container orchestration engine. There is at least one application running in the container. Container events may be generated by a container when the container changes from one state to another. Some container events may be generated while the container remains in one state. Container events being detected may include a START event, a RESTART event, and an UPDATE event, etc.

CRM 601 may include one or more instructions 620 for executing an enforcer command based on the detection, which enables an enforcer application within the container, wherein the enforcer application enabled by the enforcer command obtains performance data associated with the container and the application.

CRM 601 may also include one or more instructions 630 transmitting at least one message packet comprising the performance data to an application performance database.

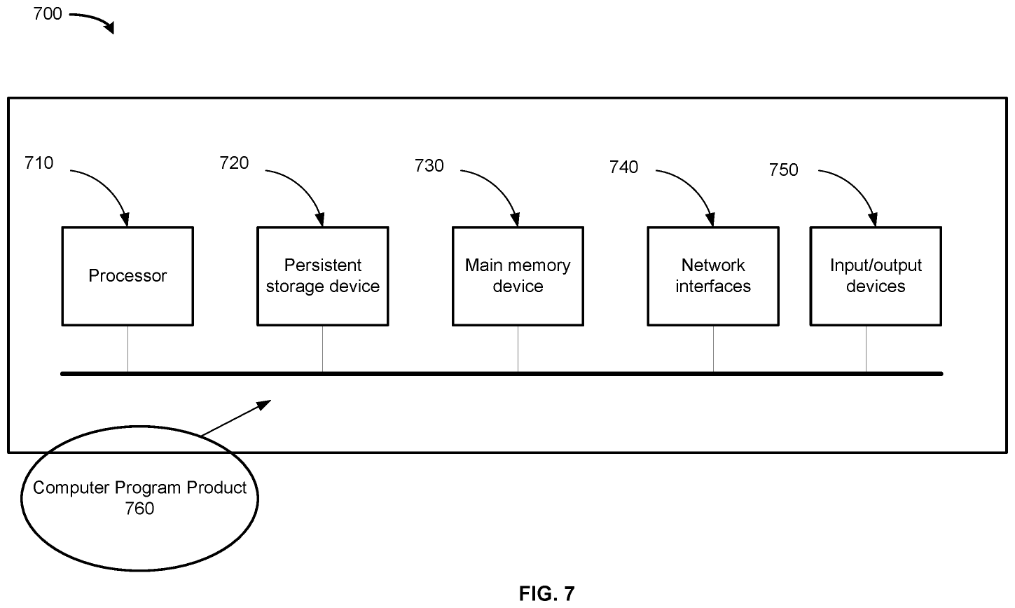

FIG. 7 illustrates a block diagram of a distributed computer system that can be used for implementing one or more aspects of the various examples. Apparatus 700 comprises a processor 710 operatively coupled to a persistent storage device 720 and a main memory device 730. Processor 710 controls the overall operation of apparatus 700 by executing computer program instructions that define such operations. The computer program instructions may be stored in persistent storage device 720, or other computer-readable medium, and loaded into main memory device 730 when execution of the computer program instructions is desired. For example, worker node 201 and application performance databases 250 and 540 may comprise one or more components of apparatus 700. Thus, the various method steps of FIGS. 3 and 4 herein can be defined by the computer program instructions stored in main memory device 730 and/or persistent storage device 720 and controlled by processor 710 executing the computer program instructions. For example, the computer program instructions can be implemented as computer executable code programmed by one skilled in the art to perform an algorithm defined by the method steps of FIGS. 3 and 4 herein. Accordingly, by executing the computer program instructions, processor 710 executes an algorithm defined by the method steps herein. Additionally, or alternatively, instructions for implementing the method steps of FIGS. 3 and 4 herein in accordance with disclosed examples may reside in computer program product 760. When processor 710 is executing the instructions of computer program product 760, the instructions, or a portion thereof, are typically loaded into main memory device 730 from which the instructions are readily accessed by processor 710.

Apparatus 700 also includes one or more network interfaces 740 for communicating with other nodes and databases in a CaaS platform via a network. Apparatus 700 may also include one or more input/output devices 750 that enable user interaction with apparatus 700 (e.g., a display, a keyboard, a mouse, speakers, buttons, etc.).

Processor 710 may include both general and special purpose microprocessors and may be the sole processor or one of multiple processors of apparatus 700. Processor 710 may comprise one or more central processing units (CPUs), and one or more graphics processing units (GPUs), which, for example, may work separately from and/or multi-task with one or more CPUs to accelerate processing. Processor 710, persistent storage device 720, and/or main memory device 730 may include, be supplemented by, or incorporated in, one or more application-specific integrated circuits (ASICs) and/or one or more field programmable gate arrays (FPGAs).

Persistent storage device 720 and main memory device 730 each comprise a tangible non-transitory computer readable storage medium. Persistent storage device 720, and main memory device 730, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 750 may include peripherals. For example, input/output devices 750 may include a display device such as a cathode ray tube (CRT), plasma or liquid crystal display (LCD) monitor for displaying information (e.g., a list of currently connected nodes in a CaaS platform) to a user, a keyboard, and a pointing device such as a mouse or a trackball by which the user can provide input to apparatus 700.

Any or all of the systems and apparatuses discussed herein, including worker node 201 and application performance databases 250 and 540, may be performed by, and/or incorporated in, an apparatus such as apparatus 700.

One skilled in the art will recognize that an implementation of an actual computer or computer system may have other structures and may contain other components as well (e.g., batteries, fans, motherboards, power supplies, etc.), and that FIG. 7 is a high-level representation of some of the components of such a computer for illustrative purposes.

The various examples are described herein with reference to the accompanying drawings, which form a part hereof, and which show, by way of illustration, specific ways of practicing the examples. This specification may, however, be construed in many different forms and should not be construed as being limited to the examples set forth herein; rather, these examples are provided so that this specification will be thorough and complete, and will fully convey the scope of the examples to those skilled in the art. Among other things, this specification may be implemented as methods or devices. Accordingly, any of the various examples herein may take the form of an entirely hardware example, an entirely software example or an example combining software and hardware aspects. The specification is, therefore, not to be taken in a limiting sense.

Throughout the specification and claims, the following terms take the meanings explicitly associated herein, unless the context clearly dictates otherwise:

The phrase “in an example” as used herein does not necessarily refer to the same example, though it may. Thus, as described above, various examples may be readily combined, without departing from the scope or spirit thereof.

As used herein, the term “or” is an inclusive “or” operator and is equivalent to the term “and/or,” unless the context clearly dictates otherwise.

The term “based on” is not exclusive and allows for being based on additional factors not described, unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices.

In addition, throughout the specification, the meaning of “a”, “an”, and “the” includes plural references, and the meaning of “in” includes “in” and “on”.

Although some of the various examples presented herein constitute a single combination of inventive elements, it should be appreciated that the inventive subject matter is considered to include all possible combinations of the disclosed elements. As such, if one example comprises elements A, B, and C, and another example comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

Throughout the above discussion, numerous references have been made regarding servers, services, interfaces, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be realized as a computer program product comprising a non-transitory, tangible computer readable medium storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network.

As used in the description herein and throughout the claims that follow, when a system, server, device, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices, including servers, interfaces, systems, databases, agents, peers, controllers, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, etc.), and may comprise various other components such as batteries, fans, motherboards, power supplies, etc. The software instructions configure or program the computing device to provide the roles, responsibilities, or other functionality as discussed below with respect to the disclosed apparatus. Further, the disclosed technologies can be realized as a computer program product that includes a non-transitory computer readable medium storing the software instructions that causes a processor to execute the disclosed steps associated with implementations of computer-based algorithms, processes, methods, or other instructions. In some examples, the various servers, systems, databases, or interfaces exchange data using standardized protocols or algorithms, possibly based on HTTP, HTTPS, AES, public-private key exchanges, web service APIs, or other electronic information exchanging methods. Data exchanges among devices can be conducted over a packet-switched network, the Internet, LAN, WAN, VPN, or other type of packet switched network; a circuit switched network; cell switched network; or other type of network.

The foregoing specification is to be understood as being in every respect illustrative, but not restrictive, and the scope of the examples disclosed herein is not to be determined from the specification, but rather from the claims as interpreted according to the full breadth permitted by the patent laws. It is to be understood that the examples shown and described herein are illustrative of the principles of the present disclosure and that various modifications may be implemented by those skilled in the art without departing from the scope and spirit of the disclosure. Those skilled in the art could implement various other feature combinations without departing from the scope and spirit of the disclosure.

1. A system comprising:
at least one memory having computer-readable instructions stored thereon which, when executed by at least one processor coupled to the at least one memory, cause the at least one processor to:
detect a container event associated with a container, wherein the container comprises an application executing therein;
based on the detection, execute an enforcer command which enables an enforcer application within the container, wherein the enforcer application enabled by the enforcer command obtains performance data associated with the container and the application; and
transmit at least one message packet comprising the performance data to an application performance database.

2. The system of claim 1, wherein when the container event comprises a START event, the at least one processor is further caused to supply at least one compatible script to initiate a new instance of an enforcer application.

3. The system of claim 1, wherein when the container event comprises a RESTART event, the at least one processor is further caused to supply at least one compatible script to restart an existing instance of an enforcer application.

4. The system of claim 1, wherein when the container event comprises an UPDATE event, the at least one processor is further caused to supply at least one compatible script to update an existing instance of an enforcer application.

5. The system of claim 1, wherein transmitting the at least one message packet comprising the performance data to an application performance database further comprises causing the at least one processor to transmit the at least one message packet to at least one message broker.

6. The system of claim 5, wherein the at least one message broker comprises a message buffering service configured to generate a database query based on the at least one message packet.

7. The system of claim 1, wherein the application performance database comprises a non-relational database.

8. The system of claim 1, wherein the at least one processor is further caused to:
retrieve the performance data from the application performance database, and
display the retrieved performance data via a visualization tool.

9. The system of claim 8, wherein displaying the retrieved performance data via a visualization tool comprises displaying the retrieved performance data in one of a histogram format or tabulated format.

10. A computerized method comprising:
detecting a container event associated with a container, wherein the container comprises an application executing therein;
based on the detection, executing an enforcer command which enables an enforcer application within the container, wherein the enforcer application enabled by the enforcer command obtains performance data associated with the container and the application; and
transmitting at least one message packet comprising the performance data to an application performance database.

11. The method of claim 10, wherein when the container event comprises a START event, the method further comprises supplying at least one compatible script to initiate a new instance of an enforcer application.

12. The method of claim 10, wherein when the container event comprises a RESTART event, the method further comprises supplying at least one compatible script to restart an existing instance of an enforcer application.

13. The method of claim 10, wherein when the container event comprises an UPDATE event, the method further comprises supplying at least one compatible script to update an existing instance of an enforcer application.

14. The method of claim 10, wherein transmitting the at least one message packet comprising the performance data to an application performance database further comprises transmitting the at least one message packet to at least one message broker.

15. The method of claim 14, wherein the at least one message broker comprises a message buffering service configured to generate a database query based on the at least one message packet.

16. The method of claim 10, wherein the application performance database comprises a non-relational database.

17. The method of claim 10, further comprising:
retrieving the performance data from the application performance database, and
displaying the retrieved performance data via a visualization tool.

18. The method of claim 17, wherein displaying the retrieved performance data via a visualization tool comprises displaying the retrieved performance data in one of a histogram format or tabulated format.

19. A computer readable medium having computer-readable instructions stored thereon, which, when executed by at least one processor, cause the at least one processor to perform one or more steps comprising:
detecting a container event associated with a container, wherein the container comprises an application executing therein;
based on the detection, executing an enforcer command which enables an enforcer application within the container, wherein the enforcer application enabled by the enforcer command obtains performance data associated with the container and the application; and
transmitting at least one message packet comprising the performance data to an application performance database.

20. The computer readable medium of claim 19, wherein when the container event comprises a START event, the one or more steps further comprise supplying at least one compatible script to initiate a new instance of an enforcer application.

21. The computer readable medium of claim 19, wherein when the container event comprises a RESTART event, the one or more steps further comprise supplying at least one compatible script to restart an existing instance of an enforcer application.

22. The computer readable medium of claim 19, wherein when the container event comprises an UPDATE event, the one or more steps further comprise supplying at least one compatible script to update an existing instance of an enforcer application.

23. The computer readable medium of claim 19, wherein transmitting the at least one message packet comprising the performance data to an application performance database further comprises transmitting the at least one message packet to at least one of a message broker or a message buffering service.

24. The computer readable medium of claim 19, wherein the at least one processor is further caused to perform one or more steps comprising:
retrieving the performance data from the application performance database, and
displaying the retrieved performance data via a visualization tool.

25. The computer readable medium of claim 24, wherein displaying the retrieved performance data via a visualization tool comprises displaying the retrieved performance data in one of a histogram format or tabulated format.
